(19) United States
(12) Patent Application Publication
(10) Pub. No.: US 2007/0285370 A1
(43) Pub. Date: Dec. 13, 2007

(54) Thin film transistor substrate and liquid crystal display panel having the same

(76) Inventor: Dong-Gyu Kim, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/701,613

(22) Filed: Feb. 2, 2007

(30) Foreign Application Priority Data
Jun. 8, 2006 (KR) 2006-51286

(51) Int. Cl. G09G 3/36

(52) U.S. Cl. 345/92; 345/87

(57) ABSTRACT

A thin film transistor substrate includes a plurality of signal lines formed in a display area, at least one fan-out line part including a plurality of fan-out lines, and a signal compensation line part including a plurality of signal compensation lines. At least a portion of at least one of the signal compensation lines includes a wave pattern. The number of cycles of the wave patterns of the signal compensation lines may be increased as a position of the signal compensation line is positioned nearer a middle portion of the signal compensation line part. The thin film transistor substrate in one embodiment includes a signal compensation electrode overlapping at least a portion of the fan-out line part or the signal compensation line part.

### CROSS-REFERENCE TO RELATED APPLICATIONS

This application claims priority to Korean Patent Application No. 10-2006-51286 filed on Jun. 8, 2006, the contents of which are herein incorporated by reference in their entirety.

### BACKGROUND OF THE INVENTION

1. Field of the Invention

The present invention relates to a thin film transistor substrate and a display device having the thin film transistor substrate. More particularly, the present invention relates to a thin film transistor substrate including fan out parts of a gate line and a data line, and a display device having the thin film transistor substrate.

2. Description of the Related Art

A thin film transistor (TFT) substrate is used as a circuit board for independently driving each pixel parts in a liquid crystal display (LCD) device or an organic light emitting diode (OLED) display device. The TFT substrate includes a scan signal line (or gate line) transmitting a scan signal, and an image signal line (or data line) transmitting an image signal. The TFT substrate further includes a TFT connected to the gate line and the data line respectively, a pixel electrode connected to the TFT, a gate insulating layer covering and insulating the gate line, and a protecting layer covering and insulating the TFT and the data line. Herein, the gate insulating layer and the protecting layer are made with silicon nitride generally.

The TFT includes a gate electrode that is a portion of the gate line, a semiconductor layer forming a channel part, a source electrode that is a portion of the data line, a drain electrode, a gate insulating layer, a protecting layer, and so on. The TFT is a switching element that transmits or breaks an image signal transmitted via the data line according to the scan signal transmitted via the gate line.

A driving circuit for applying a driving signal to the gate and data lines is connected to the TFT substrate. The driving circuit is connected to the gate line or the data line via a pad. The pad is densely formed in a narrow area to be connected with the driving circuit. On the other hand, a linear interval between the neighboring gate lines or the neighboring data lines is wider than the interval between the neighboring pads because the linear interval between the neighboring gate lines or the neighboring data lines is determined according to a size of a pixel. Therefore, a fan-out area, which is an area where the linear interval of the lines is gradually wider, is formed between a pad part and a display area. Because of the fan-out area, the lengths of the lines are different from each other, and thus each line's RC retardation is different from each other. The difference of the RC retardation causes a deviation of a kickback voltage in a pixel. Accordingly, a deviation of brightness occurs, and thus a quality of a displayed image deteriorates.

To solve the above mentioned problem, lines having a wave portion for compensating a linear deviation of a fan-out line were formed between a driving circuit and the fan-out line. The wave portion was formed shorter at an outer part of the lines whose lengths are relatively longer, and formed longer at a middle part of the lines whose lengths are relatively shorter, so that the length sum of the wave line and the fan-out line may be approximately equivalent to all the lines.

Recently, a TFT substrate on which a multi-channel driving circuit is mounted to reduce an expensive data driving circuit has been developed. The multi-channel driving circuit includes data lines more than about 1.5 times in number compared to a conventional driving circuit. Therefore, the interval between fan-out lines is so close that the wave portion is more difficult to form than before.

### SUMMARY OF THE INVENTION

The present invention obviates the above problems and thus, the present invention provides a thin film transistor substrate capable of compensating RC retardation of gate and date fan-out parts.

The present invention also provides a display device having the thin film transistor substrate.

In a thin film transistor substrate according to an exemplary embodiment of the present invention to achieve the above-mentioned purpose, the thin film transistor substrate comprises a plurality of signal lines formed in a display area having a plurality of pixels, at least one fan-out line part including a plurality of fan-out lines formed at an outer region of the display area, and a signal compensation line part including a plurality of signal compensation lines substantially parallel with the signal lines. A first end of the signal compensation line is connected to the signal line and a second end of the signal compensation line is connected to the fan-out line to connect each of the signal lines with each of the fan-out lines. At least a portion of the signal compensation lines have a wave pattern.

The number of cycles of the wave patterns of the signal compensation line may be increased as a position of the signal compensation line stands closer to a middle portion of the signal compensation line part from an outer portion thereof. The signal compensation line and the fan-out line may be formed at the same layer as the signal line.

The signal line may be at least one of a gate line and a data line. The pixel includes a first side substantially parallel with the data line and a second side substantially perpendicular to the data line, and the first side of the pixel may be shorter than the second side of the pixel.

According to an exemplary embodiment of the present invention, the fan-out line part may include at least 500 fan-out lines.

The thin film transistor substrate may, further comprise a signal compensation electrode overlapping at least a portion of the fan-out line part or the signal compensation line part. The signal compensation electrode is separated by an insulating layer from the fan-out line part and the signal compensation line part respectively.

The signal compensation electrode may include a transparent conductive material.

The signal compensation electrode may overlap a portion of the fan-out line part. The signal compensation electrode may have a shape so that an extent of an area where the signal compensation electrode overlaps the fan-out line increases as the position of the overlapped fan-out line stands closer to a middle portion of the fan-out line part from an outer portion thereof. Herein, the signal compensation electrode may have a triangle shape.

In a display device according to an exemplary embodiment of the present invention, the display device comprises a plurality of signal lines formed in a display area having a plurality of pixels, a driving part providing the signal lines with a driving signal, a fan-out line part including a plurality of fan-out lines formed at an outer region of the display area, and a signal compensation line part including a plurality of signal compensation lines formed between the signal line and the fan-out line to connect the signal line with the fan-out line. The signal compensation line is substantially parallel with the signal line. At least a portion of the signal compensation lines have a wave pattern.

### BRIEF DESCRIPTION OF THE DRAWINGS

The above and other features and advantages of the present invention will become more apparent in light of the detailed description of the exemplary embodiments with reference to the accompanying drawings, in which:

FIG. 1 is a schematic plan view illustrating a display device according to an exemplary embodiment of the present invention;

FIG. 2 is an enlarged plan view illustrating a fan-out area in FIG. 1;

FIG. 3 is a plan view illustrating a display area of a display device according to an exemplary embodiment of the present invention;

FIG. 4 is a schematic plan view illustrating a display device according to another exemplary embodiment of the present invention;

FIG. 5 is a cross-sectional view taken along a line I-I′ in FIG. 4;

FIG. 6 is a cross-sectional view of another exemplary embodiment of the present invention;

FIG. 7 is a cross-sectional view taken along a line II-II′ in FIG. 4; and

FIG. 8 is a cross-sectional view of a further exemplary embodiment of the present invention.

### DESCRIPTION OF THE EMBODIMENTS

The present invention is described below more fully with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. It will be understood that when an element is referred to as being “on” or “onto” another element, it may be directly on the other element or intervening elements may also be present. In contrast, when an element is referred to as being “directly on” another element, there are no intervening elements present. Like reference numerals refer to similar or identical elements throughout.

Hereinafter, the present invention will be explained in detail with reference to the accompanying drawings.

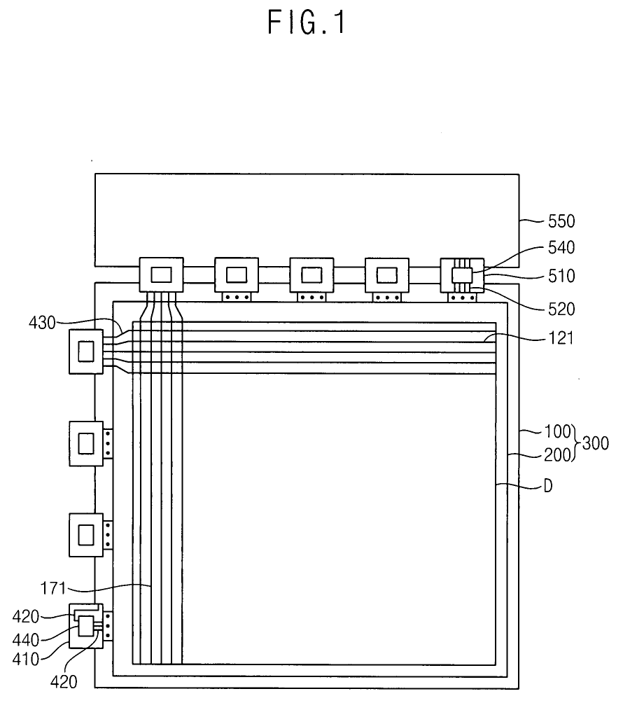

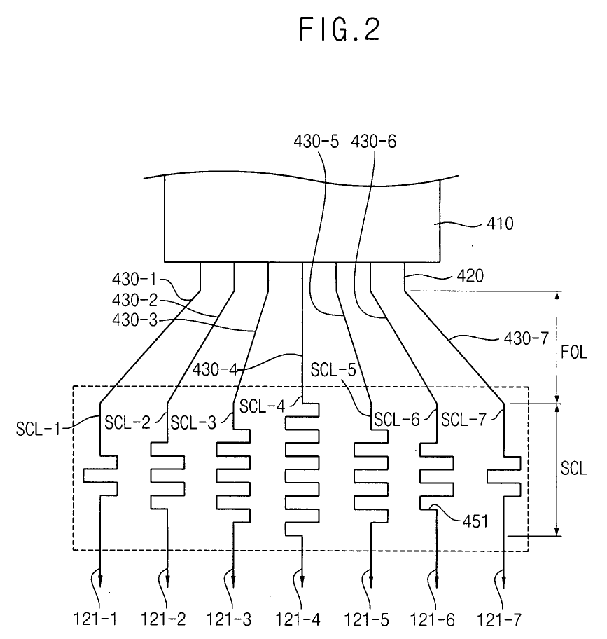

FIG. 1 is a schematic plan view illustrating a display device according to an exemplary embodiment of the present invention. FIG. 2 is an enlarged plan view illustrating the fan-out area in FIG. 1.

Referring to FIGS. 1 and 2, the display device includes a display substrate 300, a plurality of gate flexible printed circuit (hereinafter, “FPC”) substrates 410 and a plurality of data FPC substrates 510 that are attached to the display substrate 300, and a printed circuit board (hereinafter, “PCB”) 550 attached to the data FPC substrates 510.

The display substrate 300 includes a lower display substrate 100, an upper display substrate 200, and a liquid crystal layer (not shown) interposed between the display substrates 100 and 200.

Gate driving integrated circuits 440 and data driving integrated circuits (hereinafter, “IC”) 540 are mounted as a chip type on the gate and data FPC substrates 410 and 510 respectively. Also, leading-out lines 420 and 520 for connecting each of the gate and data driving ICs 440 and 540 with an exterior are formed on the gate and data FPC substrates 410 and 510 respectively. The FPC substrates 410 and 510 may be formed with polyimide or polyester, etc.

The PCB 550 includes various kinds of circuit elements for driving and controlling the display substrate 300. For example, the PCB 550 includes a signal control part (not shown), a gradation voltage generating part (not shown), and so on.

The circuit elements are connected with the data driving IC 540 via the leading-out line 520 of the data FPC substrate 510 and a signal line (not shown) formed on the PCB 550. The gate driving IC 440 is electrically connected with the PCB 550 via the leading-out line 420 of the gate FPC substrate 410, a fan-out line 430 and lines (not shown) that are separately formed at the data FPC substrate 510 and the lower display substrate 100 respectively. The leading-out lines 420 and 520 may be formed with materials having a relatively lower resistance such as copper, etc. Unlike mentioned above, the gate and data driving ICs 440 and 540 may be directly mounted on the lower display substrate 100 of the display substrate 300. In this case, the gate FPC substrate 410 may be unnecessary.

The lower display substrate 100 of the display substrate 300 may be sectioned into a display area ‘D’ and a peripheral area positioned around the display area ‘D’. A pixel electrode (not shown) is disposed in the display area ‘D’. The peripheral area is physically and electrically connected with display signal lines 121 and 171, the FPC substrates 410 and 510, and the driving ICs 440 and 540 respectively.

The signal lines 121 and 171 are connected to the pixel electrode via a switching element (not shown) in the display area ‘D’. The signal lines 121 and 171 extend parallel with each other. End portions of the signal lines 121 and 171 that are positioned in the peripheral area are connected to the FPC substrates 410 and 510 or the driving ICs 440 and 540. In the display device illustrated in FIG. 1, an interval between the neighboring leading-out lines 420 of the FPC substrates 410 and 510, which connects the driving ICs 440 and 540 with the signal lines 121 and 171, is narrower than that between the neighboring signal lines 121 and 171 of the display area ‘D’. Accordingly, the interval between the neighboring signal lines 121 and 171 is gradually changed, and thus the signal lines 121 and 171 are arranged in a fan shape. Hereinafter, the area where the signal lines 121 and 171 are arranged in a fan shape is named as a fan-out line part FOL, and each of the signal lines 121 and 171 arranged in the fan shape is named as a fan-out line 430. In FIG. 2 the fan out lines are indicated by reference characters 430-1 through 430-7. Similarly, the signal lines are indicated by reference characters 121-1 through 121-7.

Signal compensation lines SCL-1 through SCL-7 are provided for compensating a signal deviation caused by a deviation of an interval between the fan-out lines 430-1 through 430-7 of the fan-out line part FOL are formed between the fan-out lines 430-1 through 430-7 and signal lines 121-1 through 121-7. Hereinafter, the area where a plurality of the signal compensation lines SCL-1 through SCL-7 is formed is referred to as a signal compensation line part SCL.

At least a portion of the signal compensation lines SCL-1 through SCL-7 formed at the signal compensation line part SCL has a plurality of wave patterns 451 which in this embodiment are square wave patterns. Other patterns such as a saw tooth or sine wave could of course be used.

Recently, a TFT substrate on which a multi-channel driving circuit is mounted to reduce an expensive data driving circuit has been developed. The multi-channel driving circuit includes data lines more than about 1.5 times in number compared to a conventional driving circuit. Therefore, the interval between the neighboring leading-out lines 420 is so close that wave patterns are difficult to form at the leading-out line 420.

An interval between the neighboring signal compensation lines is sufficiently wider than that between the neighboring leading-out lines 420, because according to the present invention, the signal compensation lines SCL-1 through SCL-7 is formed between the fan-out line part FOL and the signal line 121. Therefore, the wave patterns 451 are easily formed at the signal compensation lines SCL-1 through SCL-7.

The signal compensation line SCL-4 formed at a middle portion of the signal compensation line part SCL has more cycles of the wave patterns 451 than the signal compensation line such as SCL-1 formed at an outer portion thereof. Therefore, the length sum of the fan-out line and the signal compensation line may be substantially the same at both the middle portion and the outer portion. For example, the length sum of the fan-out line 430-4 and the signal compensation line SCL-4 may be substantially the same as the length sum of the fan-out line 430-1 and the signal compensation line SCL-1. Accordingly, a resistance deviation of lines may be reduced, and thus a deviation of driving signals may also be reduced.

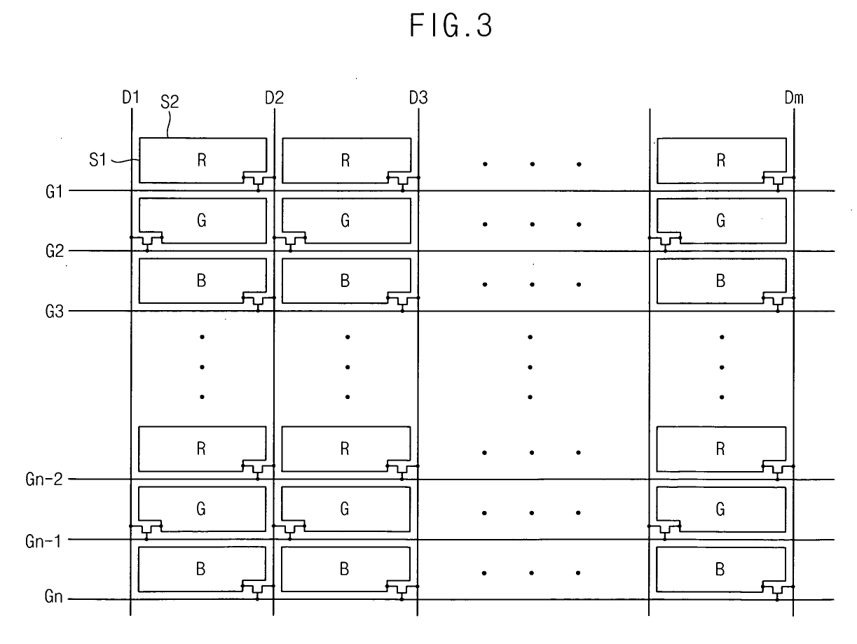

FIG. 3 is a plan view illustrating a display area of a display device according to an exemplary embodiment of the present invention.

Referring to FIG. 3, the display device includes a plurality of pixels defined by data lines (D1, . . . , Dm) and gate lines (G1, . . . , Gn). Each of the pixels has a first side S1 substantially parallel with data lines (D1, . . . , Dm), and a second side S2 substantially perpendicular to the data lines (D1, . . . , Dm). Herein, the length of the first side of the pixel may be shorter than that of the second side of the pixel.

Color filters such as a red color filter, a green color filter, a blue color filter, etc may be arranged in a horizontal stripe type because a horizontal length of the pixel is longer than a vertical length thereof. That is, the color filters such as a red color filter, a green color filter, a blue color filter, etc may be successively and repeatedly arranged along the data lines (D1, . . . , Dm).

The arrangement of the pixel as mentioned above is useful to reduce the number of data driving circuits. According to the above-mentioned arrangement of the pixel, an interval between data signal lines is longer compared to a conventional pixel-arrangement. Therefore, a sufficient space for forming a signal compensation line between a fan-out line and a signal line may be provided in particular, when a multi-channel driving circuit is used.

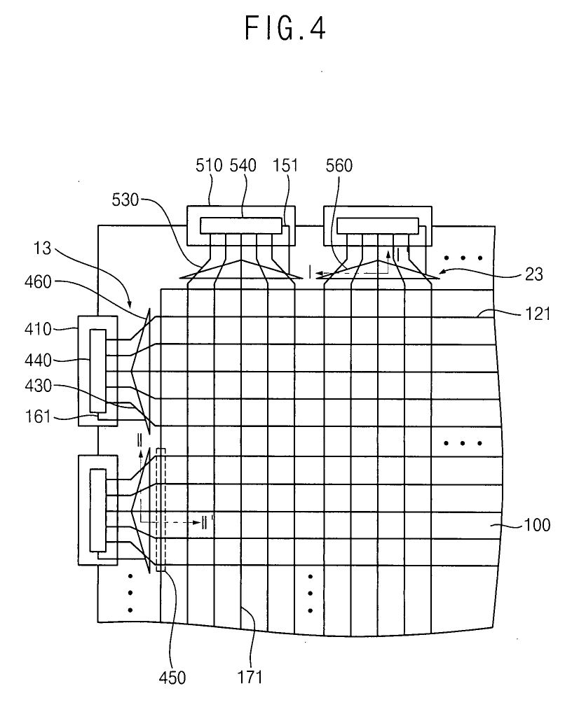

FIG. 4 is a schematic plan view illustrating a display device according to another exemplary embodiment of the present invention.

Elements of the fan-out line part and so on are previously described referring to FIGS. 2 and 3, and thus detailed and repeated descriptions will be omitted.

Referring to FIG. 4, fan-out line parts 13 and 23 overlap signal compensation electrodes 460 and 560 having a triangle shape. The signal compensation electrodes 460 and 560 include a gate signal compensation electrode 460 and a data signal compensation electrode 560. The gate signal compensation electrode 460 overlaps a gate fan-out line part 13, and the data signal compensation electrode 560 overlaps a data fan-out line part 23. The overlapping areas where the signal compensation electrodes 460 and 560 overlap the fan-out line parts 13 and 23 respectively are broader in a middle portion of the fan-out line parts 13 and 23 than in an outer portion thereof. That is, a length of fan-out lines 430 and 530 overlapping the signal compensation electrodes 460 and 560 is relatively longer in the middle portion of the fan-out line parts 13 and 23, and is relatively shorter in the outer portion thereof. In other words, a capacitance between each signal compensation electrodes 460 and 560 and each fan-out lines 430 and 530 is relatively larger in the middle portion, and is relatively smaller in the outer portion.

A resistance of each of the fan-out lines 430 and 530 is smaller in the middle portion of the fan-out line parts 13 and 23, and is larger in the outer portion thereof.

Accordingly, the product of the resistance and the capacitance of each fan-out lines 430 and 530 are regularly regardless of the position. Therefore, the RC retardation caused by a length deviation of the fan-out lines 430 and 530 may be effectively compensated by the capacitance produced through the signal compensation electrodes 460 and 560.

The length of the fan-out lines 430 and 530 and the extent of the overlapping area where the signal compensation electrodes 460 and 560 overlap the fan-out lines 430 and 530 are determined considering the RC retardation produced in the signal line of the TFT substrate 100.

Although the signal compensation electrode overlaps the fan-out line in this exemplary embodiment, the signal compensation electrode may be formed to overlap the signal compensation line in another exemplary embodiment.

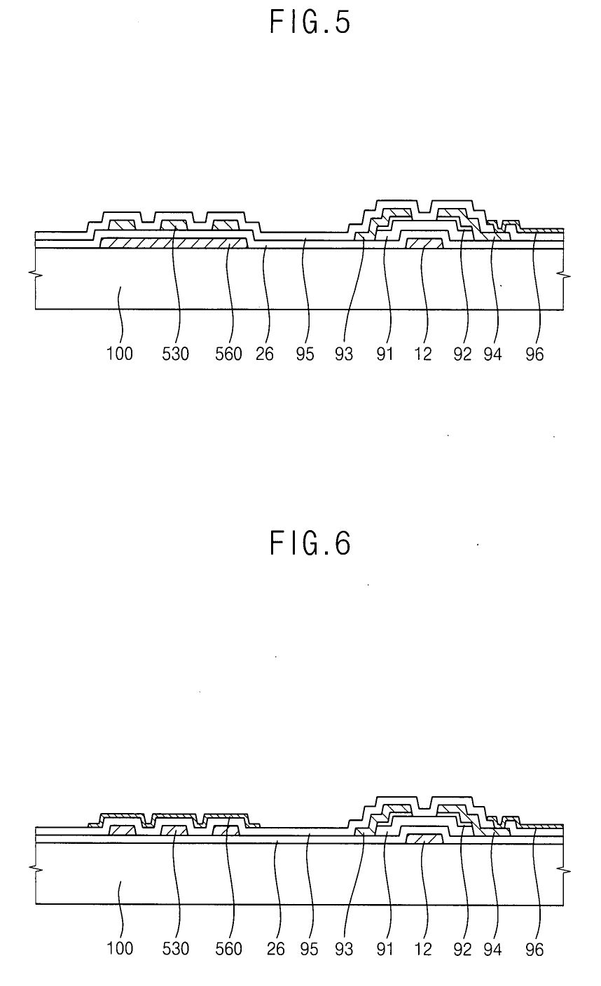

FIG. 5 is a cross-sectional view taken along a line I-I′ in FIG. 4.

Referring to FIGS. 4 and 5, a plurality of gate lines 121 is formed on an insulating substrate 100. The insulating substrate 100 includes insulating materials such as glass, quartz, ceramic and plastic. A portion of the gate line 121 branches off to form a gate electrode 12. A data signal compensation electrode 560 is formed at the same layer as the gate line 121 and the gate electrode 12.

Although each of the gate line 121 and the signal compensation electrode 560 is formed as a single layer, those may be formed as a multi layer to complement a fault of metal or alloy and to obtain required properties. For example, the multi-layer comprises a lower layer including aluminum or aluminum alloy, etc, and an upper layer including chrome, molybdenum, molybdenum-tungsten or molybdenum-tungsten nitride. That is, aluminum or aluminum alloy having relatively low resistivity is used as the lower layer to prevent a signal resistance caused by wiring resistance, and chrome, molybdenum, molybdenum-tungsten or molybdenum-tungsten nitride having relatively high corrosion-resistance against chemicals is used as the upper layer to complement the fault of aluminum or aluminum alloy, which is easily corroded and oxidized by chemicals and thus is easy to break down electrically. Recently, molybdenum (Mo), aluminum (Al), titanium (Ti), tungsten (W), etc are spotlighted as wiring materials.

A gate insulating layer 26 is formed over the gate line 121, the gate electrode 12 and the data signal compensation electrode 560. The gate insulating layer 26 may include silicon nitride (SiNx).

A semiconductor layer 91 including a semiconductor such as hydrogenated amorphous silicon, etc is formed on the gate insulating layer 26 where the gate electrode 12 is disposed. A resistant contact layer 92 including n+ hydrogenated amorphous silicon doped with n+ type impurities having high concentration is formed on the semiconductor layer 91. Herein, the resistant contact layer 92 is separated into two parts centering the gate electrode 12.

A source electrode 93 and a drain electrode 94 are formed on the resistant contact layer 92. Fan-out lines or signal compensation lines 530 are formed at the same layer as the source and drain electrodes 93 and 94. Although amorphous silicon layers 91 and 92 on the gate insulating layer 26 are etched and eliminated in FIG. 5, the amorphous silicon layers 91 and 92 may remain on the gate insulating layer 26 when the amorphous silicon layer and the data line layer are formed through one light-exposure process.

The gate insulating layer 26 is interposed between the data signal compensation electrode 560 and the Fan-out lines or signal compensation lines 530, and thus the three components constitute a capacitor.

The source electrode 93 and the drain electrode 94 are also a single layer or a multi layer including a metal layer. A protecting layer 95 including a silicon nitride (SiNx), for example, is formed over the data line. The protecting layer 95 has a contact hole exposing the drain electrode 94. A pixel electrode 96 receiving an image signal from the TFT is formed on the protecting layer 95. The pixel electrode 96 is coupled with a common electrode of an upper substrate to generate an electric field. The pixel electrode 96 is physically and electrically connected with the drain electrode 94 via the contact hole to receive the image signal. Although the pixel electrode 96 is formed at a different layer from where the data signal compensation electrode 560 is formed, the data signal compensation electrode 560 and the pixel electrode 96 may be formed at the same layer.

FIG. 6 is a cross-sectional view showing another exemplary embodiment of the present invention. The same reference numerals are used to refer to similar or the same elements as those previously described in FIG. 5, and any further detailed and repeated descriptions concerning the same elements will be omitted.

Referring to FIG. 6, a data signal compensation electrode 560 is formed at the same layer as a pixel electrode 96. That is, a protecting layer 95 including silicon nitride, etc is disposed between data fan-out lines or data signal compensation lines 530 and the data signal compensation electrode 560.

The data signal compensation electrode 560 and the pixel electrode 96 are patterned last together, after forming the protecting layer 95. The data signal compensation electrode 560 includes a transparent conductive material such as indium tin oxide (ITO), and indium zinc oxide (IZO).

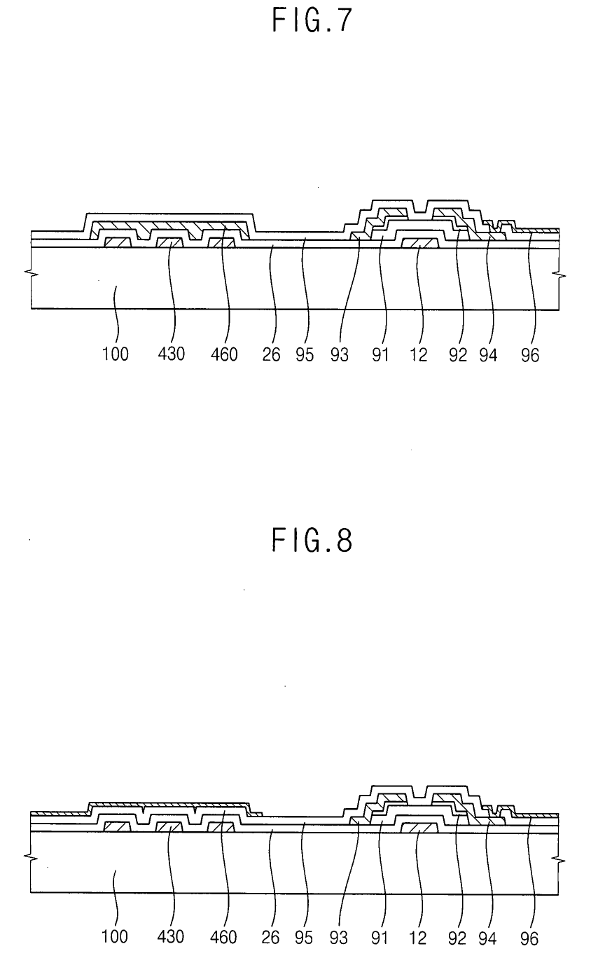

FIG. 7 is a cross-sectional view taken along a line II-II′ in FIG. 4. FIG. 7 is a cross-sectional view concerning a gate signal compensation electrode. Any further detailed and repeated descriptions concerning the same elements previously described in FIG. 5 are omitted.

Referring to FIGS. 4 and 7, a gate signal compensation electrode 460 lo separately covers gate fan-out lines or gate signal compensation lines 430. The gate signal compensation electrode 460 overlaps the gate fan-out lines or gate signal compensation lines 430, and thus the gate signal compensation electrode 460 is coupled with the gate fan-out lines or gate signal compensation lines 430 to constitute a capacitor.

The gate signal compensation electrode 460 is formed at the same layer as a source electrode 93 and a drain electrode 94 that are formed over a gate electrode 12. The gate signal compensation electrode 460 is formed in the gate fan-out part 13 when a data line including the source electrode 93 and the drain electrode 94 is patterned. Accordingly, the gate signal compensation electrode 460 coupled with the gate fan-out part 13 may institute a capacitor. Although the gate signal compensation electrode 460, the source electrode 93 and the drain electrode 94 are formed at the same layer, those are physically separated from each other and thus are not electrically contacted with each other.

FIG. 8 is a cross-sectional view for explaining another exemplary embodiment of the present invention. Any further detailed and repeated descriptions concerning the same elements previously described in FIG. 7 have been omitted.

Referring to FIG. 8, a gate signal compensation electrode 460 is formed at the same layer as a pixel electrode 96, not the same layer as a source electrode 93 or a drain electrode 94. That is, a gate insulating layer 26 and a protecting layer 95 that include silicon nitride are disposed between gate fan-out lines 430 and the gate signal compensation electrode 460.

The gate signal compensation electrode 460 and the pixel electrode 96 are patterned last together, after forming the protecting layer 95. The gate signal compensation electrode 460 includes a transparent conductive material such as indium tin oxide (ITO), or indium zinc oxide (IZO).

Referring to FIG. 4 again, a structure of a data fan-out part 23 and a data signal compensation electrode 560 is similar to that of the gate fan-out part 13 and the gate signal compensation electrode 460, which is described above. Describing the cross-section of the data fan-out part 23, a gate insulating layer 26 and a protecting layer 95 are sequently piled up on the insulating substrate 100, and a pixel electrode 90 is formed at the same layer as the data signal compensation electrode 560, on the protecting layer 95.

The present exemplary embodiments employ capacitance compensation together as well as the resistance compensation shown in FIG. 1, so that the RC retardation may be more effectively compensated.

According to the present invention as described above, a signal compensation line is formed between a fan-out line part and a signal line where an interval between the neighboring lines is sufficiently broader than that between leading-out lines that are led out from a driving circuit. Therefore, it may be easier to form wave patterns at a plurality of lines. Also, a signal compensation electrode and a signal compensation line may be formed together, so that capacitance compensation may be achieved as well as resistance compensation. Therefore, a deviation of signal retardation may be effectively improved.

Although exemplary embodiments of the present invention have been described, it is understood that the present invention is not limited to these exemplary embodiments but various changes and modifications can be made by one ordinary skilled in the art within the spirit and scope of the present invention as hereinafter claimed.

What is claimed is:

1. A thin film transistor (TFT) substrate comprising:
a plurality of signal lines formed in a display area having a plurality of pixels;
at least one fan-out line part including a plurality of fan-out lines formed at an outer region of the display area; and
a signal compensation line part including a plurality of signal compensation lines, wherein a first end of each signal compensation line is connected to an associated signal line and a second end of each signal compensation line is connected to an associated fan-out line to connect each of the signal lines to the associated fan-out line, and further wherein at least first one of the signal compensation lines has a first length and a second one of the signal compensation lines has a second length which is different from the first length.

2. The TFT substrate of claim 1, wherein at least one of the first and second signal compensation lines comprises a wave pattern.

3. The TFT substrate of claim 1, wherein each of the signal compensation lines has a wave pattern, and a number of cycles of the wave pattern in the first one of the signal compensation lines is different from that of the wave pattern in the second one of the signal compensation lines.

4. The TFT substrate of claim 3, wherein the number of cycles of the wave pattern increases as a position of a signal compensation line is nearer a middle portion of the signal compensation line part from an outer portion of the signal compensation line part.

5. The TFT substrate of claim 1, wherein the signal lines, the signal compensation lines, and the fan-out lines are formed from a common layer of material.

6. The TFT substrate of claim 1, wherein the signal line corresponds to at least one of a gate line and a data line.

7. The TFT substrate of claim 6, wherein each pixel includes a first side substantially parallel with the data line and a second side substantially perpendicular to the data line, and further wherein the first side of each pixel is shorter than the second side of each pixel.

8. The TFT substrate of claim 1, further comprising a signal compensation electrode overlapping at least a portion of the fan-out line part or the signal compensation line part; and
an insulating layer interposed between the signal compensation electrode and the fan-out line part or the signal compensation line part.

9. The TFT substrate of claim 8, wherein the signal compensation electrode includes a transparent conductive material.

10. The TFT substrate of claim 8, wherein the signal compensation electrode overlaps a portion of the fan-out line part.

11. The TFT substrate of claim 10, wherein the signal compensation electrode is shaped such that the amount of an overlapping area where the signal compensation electrode overlaps the fan-out line increases as the position of the overlapped fan-out line is positioned toward a middle portion of the fan-out line part from an outer portion thereof.

12. The TFT substrate of claim 11, wherein the signal compensation electrode has a triangular shape.

13. The TFT substrate of claim 1, wherein the fan-out line part includes at least 500 fan-out lines.

14. The TFT substrate of claim 13, further comprising a signal compensation electrode overlapping at least a portion of the fan-out line part or the signal compensation line part; and
an insulating layer interposed between the signal compensation electrode and the fan-out line part or the signal compensation line part.

15. The TFT substrate of claim 14, wherein the signal compensation electrode overlaps a portion of the fan-out line part.

16. The TFT substrate of claim 15, wherein the signal compensation electrode is shaped such that of the amount of an overlapping area where the signal compensation electrode overlaps the fan-out line increases as the position of the overlapped fan-out line is positioned toward a middle portion of the fan-out line part from an outer portion thereof.

17. The TFT substrate of claim 16, wherein the signal compensation electrode has a triangular shape.

18. A display device comprising:
a plurality of signal lines formed in a display area having a plurality of pixels;
a driving part for providing the signal lines with a driving signals;
a fan-out line part including a plurality of fan-out lines formed at an outer region of the display area, a first end of the fan-out lines being connected with the driving part; and
a signal compensation line part including a plurality of signal compensation lines formed between the signal lines and the fan-out lines to connect the signal lines with the fan-out lines, each signal compensation line being substantially parallel with the signal lines, and wherein at least a portion of at least one of the signal compensation lines includes a wave pattern.

19. The display device of claim 18, wherein the signal compensation lines include wave patterns and a number of cycles of the wave patterns increases as a position of a signal compensation line is nearer a middle portion of the signal compensation line part from an outer portion of the signal compensation line part.

20. The display device of claim 19, wherein the signal compensation line and the fan-out line are formed at the same layer as the signal line.

21. The display device of claim 20, wherein the signal line corresponds to at least one of a gate line and a data line.

22. The display device of claim 21, wherein the display device includes at least one pixel, and the pixel includes a first side substantially parallel with the data line and a second side substantially perpendicular to the data line, and the first side of the pixel is shorter than the second side of the pixel.

23. The display device of claim 19, further comprising a signal compensation electrode overlapping at least a portion of the fan-out line part or the signal compensation line part; and
an insulating layer interposed between the signal compensation electrode and the fan-out line part or the signal compensation line part.

24. The display device of claim 23, wherein the signal compensation electrode includes a transparent conductive material.

25. The display device of claim 24, wherein the signal compensation electrode overlaps a portion of the fan-out line part.

26. The display device of claim 25, wherein the signal compensation electrode is shaped such that the amount of an overlapping area where the signal compensation electrode overlaps the fan-out line increases as the position of the overlapped fan-out line stands closer to a middle portion of the fan-out line part from an outer portion thereof.

27. The display device of claim 26, wherein the signal compensation electrode has a triangular shape.

28. The display device of claim 19, wherein the fan-out line part includes at least 500 fan-out lines.

29. The display device of claim 28, further comprising a signal compensation electrode overlapping at least a portion of the fan-out line part or the signal compensation line part; and
an insulating layer interposed between the signal compensation electrode and the fan-out line part or the signal compensation line part.

30. The display device of claim 29, wherein the signal compensation electrode overlaps a portion of the fan-out line part.

31. The display device of claim 30, wherein the signal compensation electrode is shaped such that the amount of an overlapping area where the signal compensation electrode overlaps the fan-out line increases as the position of the overlapped fan-out line stands closer to a middle portion of the fan-out line part from an outer portion thereof.

32. The display device of claim 31, wherein the signal compensation electrode has a triangle shape.
